(19) United States
(12) Patent Application Publication
(10) Pub. No.: US 2008/0028002 A1
(43) Pub. Date: Jan. 31, 2008

(54) Content publishing system and method

(76) Inventors: Jason E. Barkeloo, Cincinnati, OH (US); David A. Krauth, Manchester, NH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/881,813

(22) Filed: Jul. 27, 2007

Related U.S. Application Data
(60) Provisional application No. 60/833,578, filed on Jul. 27, 2006.
(60) Provisional application No. 60/833,580, filed on Jul. 27, 2006.

(51) Int. Cl. G06F 12/16

(52) U.S. Cl. 707/201; 707/E17.007

(57) ABSTRACT

It is a first aspect of the present invention to provide a content publishing system that includes back end digital content capable of being modified, an interactive user device displaying fixed front end content, the interactive user device further adapted to transmit one or more request signals associated with the fixed front end content, a server device adapted to store back end digital content and transmit one or more response signals associated with the back end digital content in response to receiving the or more request signals, and a user computer device adapted to receive the one or more response signals associated with the back end digital content, the user computer device further adapted to output the back end digital content on an output device. The one or more response signals correspond to back end digital content.

### CROSS-REFERENCE TO RELATED APPLICATIONS

This application claims the benefit of U.S. Provisional Application Ser. No. 60/833,578, entitled “PRESCRIPTIVE PUBLISHING SYSTEM AND METHOD,” filed on Jul. 27, 2006, and U.S. Provisional Application Ser. No. 60/833,580, entitled “SYSTEM AND METHOD FOR USING LEARNING AND DIGITAL CONTENT OBJECTS TO DEVELOP INTERACTIVE HYBRID PRINTED MATERIAL,” filed on Jul. 27, 2006, the disclosures of which are incorporated herein by reference.

### FIELD OF THE INVENTION

The present invention relates to a system and method for publishing content by a publisher or a third party. In an exemplary embodiment, the present invention relates to publishing digital content based, at least in part, on a user's attributes, needs or requirements.

### BACKGROUND OF THE INVENTION

Innovations have begun to transform conventional books and other printed publications into multi-media interactive devices. Printed publications have been fitted to connect electronically with computers and other media storage devices to retrieve and display digital content. In some instances, the printed publications have an integrated remote control device capable of interacting wirelessly with the media storage devices and in other instances, the printed publications are tethered to the media storage devices with a local connection such as a USB connection or cable connection. This technology enables, for example, a reader to press the pictures and words on the regular printed ink and paper page and retrieve digital content from a computer or other media storage device.

To fully utilize this technology, users would need to tailor the printed and/or digital content to meet their needs. Alternatively, a third party such as a teacher or doctor would need to tailor the content based on a user's needs. Therefore, it would be preferable to provide a personalized digital content publishing system and method. No such system or method is currently available. Accordingly, the present invention is designed to overcome shortcomings in the current market.

### SUMMARY OF THE INVENTION

The present invention solves the above problems by providing a content publishing method allowing a third party or the publisher to modify content based, at least in part, on a user's attributes, needs or requirements.

It is a first aspect of the present invention to provide a content publishing system that includes back end digital content capable of being modified, an interactive user device displaying fixed front end content, the interactive user device further adapted to transmit one or more request signals associated with the fixed front end content, a server device adapted to store back end digital content and transmit one or more response signals associated with the back end digital content in response to receiving the or more request signals, and a user computer device adapted to receive the one or more response signals associated with the back end digital content, the user computer device further adapted to output the back end digital content on an output device. The one or more response signals correspond to back end digital content.

In one embodiment of the first aspect, the back end digital content is modified by at least one of a publisher and a third party. In another embodiment of the first aspect, the back end digital content is modified by at least one of the publisher and the third party based, at least in part, on at least one of one or more requirement of a user and one or more attribute of the user. In another embodiment of the first aspect, the one or more attribute of the user includes at least one of interests, skill levels, learning disabilities and physical disabilities. In yet another embodiment of the first aspect, the back end digital content is modified by at least one of the publisher and the third party based, at least in part, on advice of the third party. In another embodiment of the first aspect, the third party may be a teacher, a professor, an educational tutor, an employer, a guidance counselor, a physician, a pediatrician, a psychologist or a psychiatrist.

It is a second aspect of the present invention to provide a method of publishing content that includes the steps of: providing a server device for storing digital content, a client device for outputting the digital content, and an interactive user device for generating one or more signal associated with retrieval of the digital content from the server device based, at least in part, on input of a user, determining by a third party one or more attributes of the user, modifying the digital content by at least one of a publisher and the third party based, at least in part, on the one or more attributes of the user, and transmitting the modified digital content from the server device to the client device. In one embodiment of the second aspect, prior to the modifying step, the additional step of transmitting the one or more attributes of the user to the publisher of the digital content is included. In another embodiment of the second aspect, prior to the modifying step, the additional step of creating the digital content by at least one of a publisher and the third party is included. In another embodiment of the second aspect, prior to the step of transmitting the modified digital content from the server device to the client device, the step of transmitting from the interactive user device to the server device the one or more signals associated with retrieval of the digital content is included. In another embodiment of the second aspect, the third party may a teacher, a professor, an educational tutor, an employer, a guidance counselor, an employer, a physician, a pediatrician, a psychologist and a psychiatrist.

It is a second aspect of the present invention to provide a method of publishing content that includes the steps of: providing a server device for storing digital content, a client device for outputting the digital content, and an interactive user device for generating one or more signal associated with retrieval of the digital content from the server device based, at least in part, on input of a first person, observing a first person by a second person, determining by the second person one or more needs of the first person based, at least in part, on the observing step, transmitting from the interactive user device to the server device the one or more signals associated with retrieval of the digital content, and transmitting from the server device to the client device digital content corresponding to the one or more needs of the first person.

In one embodiment of the third aspect, the method further includes the step of: prior to transmitting from the server device to the client device digital content, communicating the one or more needs of the first person by the second person to a publisher. In another embodiment of the third aspect, the method further includes the step of: prior to transmitting from the server device to the client device digital content, modifying the digital content by at least one of a publisher and the second person based, at least in part, on the one or more needs of the first person. In another embodiment of the third aspect, the observing step includes at least one of: watching the first person interact with at least one of the interactive user device and a third person, and asking the first person questions associated with the first person. In yet another embodiment of the third aspect, the second person is one of a teacher, a professor, an educational tutor, a guidance counselor, an employer, a physician, a pediatrician, a psychologist and a psychiatrist.

From the foregoing disclosure and the following detailed description of various preferred embodiments it will be apparent to those skilled in the art that the present invention provides a significant advance in the art of publishing systems and methods. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 is a flow diagram of an exemplary embodiment for the publishing method and system, and

FIG. 2 is a flow diagram of an exemplary embodiment for the publishing method and system.

### DETAILED DESCRIPTION

It will be apparent to those skilled in the art that many uses and variations are possible for the system and method disclosed herein. The following detailed discussion of various alternative and preferred embodiments will illustrate the general principles of the invention. Other embodiments will be apparent to those skilled in the art given the benefit of this disclosure.

Recently, printed publications have been fitted to connect electronically with computers and other media storage devices to retrieve and display digital content 20 (herein, “interactive hybrid printed material” 22 or “IHPM” 22). In some instances, the printed publications have an integrated remote control device capable of interacting wirelessly with the media storage devices (herein, a “remote interactive hybrid printed material” 22 or “remote IHPM” 22), and in other instances, the printed publications are tethered to the media storage devices with a local connection such as a USB connection or cable connection. This technology enables, for example, a reader to press the pictures and words on the regular printed ink and paper page and retrieve digital content 20 from a computer or other media storage device. Examples of such IHPMs 22 are described in U.S. Pat. Nos. 5,624,265, 5,757,304, 5,749,735, 5,763,112, 5,788,507, 5,839,905, 5,911,582, 5,957,695, 6,327,459 and 6,650,867, the disclosures of which are incorporated by reference.

A remote interactive hybrid printed material 22 includes a remote control circuitry, a printed publication having printed content, and a membrane switch connected to the remote control circuitry. The membrane switch may be any type of device capable of sensing and responding to pressure—for example, a push button, koala pad, or touch sensitivity pad. In an exemplary embodiment, the membrane switch of the remote interactive hybrid printed material 22 has a visual association with text and/or graphic content on the remote control. The associated electronic content and the membrane switch have a remote electronic association implemented through a wireless signal encoded with the remote IHPM 22.

When the user touches the text and/or graphics on the interactive hybrid printed material 22, pressure from the touch operates the underlying membrane switch. In response to the activation of the membrane switch, the circuitry of the interactive hybrid printed material 22 generates and transmits a signal to a host device 23. As used herein, the term “host device” 23 is intended to mean any electronic device such as a computer, television, personal digital assistant, or cell phone that is capable of outputting or displaying associated digital content 20. The signal from the IHPM 22 carries data (e.g., x and y coordinates) indicative of the touched location on the interactive hybrid printed material 22. In an exemplary embodiment, he host device 23 will have access to the source 25 of the associated digital content 20 over a data connection such as a network connection (e.g. the Internet); but it is within the scope of the invention that the associated digital content 20 resides on the host device 23. It is also within the scope of the invention that the host device 23 and the IHPM 22 be integrated into a single device.

In an exemplary embodiment, the source 25 of back end digital content 20 is a server device 25. Such a server device 25 may include any device capable of storing back end digital content 20 or digital information. The server device 25 on which at least part of the exemplary system is operating (and which may appear in the appended claims) may be a single computer server device, a networked group of computer servers, or any other networked computer device or computerized device or system of computer devices or computerized devices on which the tools and/or processes of the exemplary embodiments may operate. In one embodiment, the server device 25 has the ability to generate and transmit one or more signals associated with requesting back end digital content 20. These signals would be transmitted in response to receiving a request signal from an IHPM 22.

An exemplary embodiment of the present invention may integrate the interactive hybrid printed material 22 and the host device 23. In such an embodiment, the IHPM 22 and the host device 23 of the present embodiment may be combined into a single device. In this embodiment, the IHPM 22 may include the printed publication having printed content and the membrane switch. The IHPM 22 will also be wired to circuitry that transmits the touch location and other information over local or networked connections. By combining the IHPM 22 and the host device 23, the system may require less hardware, thus reducing the system cost.

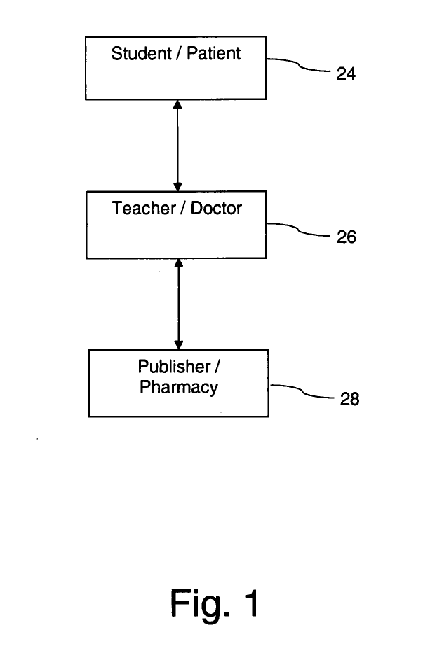

Referring to FIG. 1, in a first exemplary embodiment of the publishing method and system, a student 24 interacts with a teacher 26 who also interacts with a publisher 28 of back end digital content 20. The student's 24 interaction with the teacher 26 can be transparent, intentional or a combination of both. For example, in a transparent interaction, a teacher 26 may observe trends or patterns in the student's 24 use of the IHPM 22 (e.g., noticing that the student 24 activates a “help” object every time a certain type of puzzle is presented in the printed publication). In another example, in an intentional interaction, the student 24 may contact the teacher 26 directly, requesting assistance or providing feedback.

The teacher 26 or teaching team 26 may diagnose the student 24 and prescribe the type or kind of back end content 20 to be provided by the publisher 28. This prescription of information is sent to the publisher 28, at which point the publisher 28 selects back end content 20 that is appropriate in light of the prescription from the teacher 26. The publisher 28 then provides the back end content 20 to the teacher 26 or directly to the student 24.

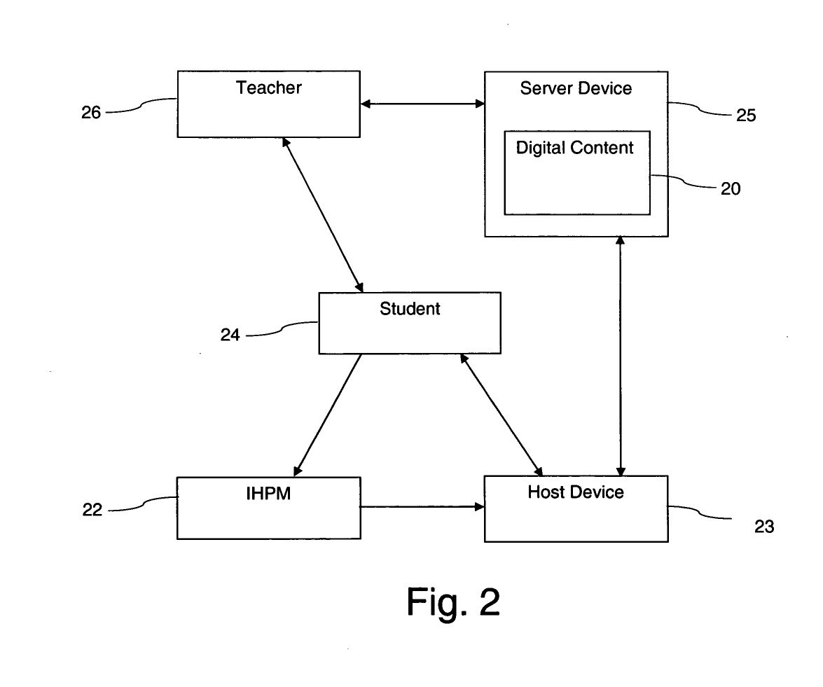

Referring to FIG. 2, in another exemplary embodiment of the publishing method and system, the student 24 interacts with the teacher 26, the interactive hybrid printed material 22, and the host device 23. When the student 24 activates the interactive hybrid printed material 22, a signal is transmitted by the host device 23 to retrieve digital content 20 from the server device 25 prescribed by the teacher 26. In another embodiment, the teacher 26 or administrator 26 may prescribe the solution to the student's 24 problem by interacting with a publisher 28.

The back end digital content 20 is modifiable by a publisher 28 or a teacher 26 based upon the needs or requirements of the user 24 (e.g., the student 24). As used herein, “back end content” 20 and “back end digital content” 20 refer to the content that resides in the digital space (such as a server device 25 as shown in FIG. 2) and is retrieved and outputted upon actuation of the membrane switch on the interactive hybrid printed material 22. As used herein, “front end content” is the content that resides on the printed page, also known as printed material. Since this content is printed on the page, it is fixed content. In an exemplary embodiment, the information to be retrieved and outputted on the host device 23 can be readily modified by a publisher 28 to provide a customized solution for the user 24 of the interactive hybrid printed material 22. As such, back end content 20 is not fixed; it is dynamic and modifiable.

In an exemplary embodiment, the publishing method and system is considered to be analogous to the procedure for receiving a prescription drug. In order to receive a prescription drug, the patient 24 is diagnosed or evaluated by a care provider 26. The care provider 26 offers a prescription drug solution for the diagnosed problem but does not directly supply the drug. The prescription is provided to the pharmacy 28. The pharmacy 28 fills the order after checking for potential negative interactions, prescription errors, proper dosage, etc. In a similar manner, an exemplary embodiment of the publishing method offers a solution to the user's 24 diagnosed problem: the publishing method and system has the teacher 26 in the capacity of the care provider 26, diagnosing a student's 24 learning styles and/or special needs. In an exemplary embodiment, for example, if the student 24 has a visual impairment such as blindness, the teacher 26 may “prescribe” a textbook with a Braille front end content and auditory back end content 20. This prescription by the teacher 26 is given to the publisher 28 of the back end content 20. The publisher 28 provides back end content 20 tailored to the student's 24 needs in accordance with the order from the teacher 26.

In one embodiment, the teacher 26 or other third party diagnoses the user's 24 (e.g., a student's 24) problem and suggests a solution to the publisher 28 of the back end content 20. In yet another embodiment, the teacher 26 or other third party simply provides information about the user 24 (e.g., a student 24) to the publisher 28 and the publisher 28 provides the solution. For example, the teacher 26 provides the symptoms of the student 24 to the publisher 28 without diagnosing the problem, and the publisher 28 of the back end content 20 diagnoses and provides a solution. In this case, the publisher 28 modifies the back end content 20 based on the information provided by the teacher 26.

In another embodiment, the teacher 26 or other third party develops an individualized education plan for the user 24 of the interactive hybrid printed material 22. As used herein, “individualized education plan” is any plan developed by the teacher 26 or third party that is tailored to the needs or requirements of the individual user 24. The teacher 26 or third party submits the individualized education plan to the publisher 28. The publisher 28 selects the appropriate content 20 to meet the individualized education plan, bundles it and makes the back end digital content 20 available to the user 24.

In one embodiment of the present invention, the publishing method and system allows teachers 26 and other individuals to develop back end digital content 20. Instead of relying on outside publishers 28 to provide the back end digital content 20 for retrieval and output on a host device 23, individuals are enabled to design and “publish” the back end digital content 20.

Again referring to FIG. 1, in one embodiment of the present invention, the teacher 26 or teaching team 26 diagnoses the student 24 and prescribes the type or kind of back end content 20 to be provided. This teacher 26 or teaching team 26 then writes, designs, creates and/or chooses the information to be provided as back end digital content 20 and makes the information available to be retrieved as back end digital content 20.

In an exemplary embodiment, the student 24 interacts with the teacher 26, the interactive hybrid printed material 22, and the host device 23. The teacher 26 selects and provides back end digital content 20 for a student 24. The teacher 26 does not need to rely on a publisher 28 to write, create, design, and/or choose the material that serves as the back end digital content 20. Instead, the teacher 26 is able to select and provide the back end digital content 20 by himself. When the student 24 activates the interactive hybrid printed material 22, a signal is transmitted by the host device 23 to retrieve digital content 20 prescribed and provided by the teacher 26.

The back end digital content 20 is modifiable by a teacher 26 or other individual based upon the needs, wants and/or requirements of the user 24. In another embodiment, the teacher 26 or other individual working with a user 24 of an interactive hybrid device 22 both determines the type and/or kind of information that is to be retrieved by the user 24 and provides this information by writing, designing, creating and/or choosing the back end digital content 20. For example, for the student 24 with a visual impairment described above, the teacher 26 can prescribe a textbook with Braille front end content on the IHPM 22 and auditory back end content 20. The teacher 26 may then take the next step and write, design, create and/or choose the appropriate type and kind of auditory back end content 20. The teacher 26 provides back end content 20 tailored to the student's 24 needs.

In an exemplary embodiment of the present invention, an individual writes, designs, creates, and/or chooses back end digital content 20 for the interactive hybrid printed material 22. In one exemplary embodiment, the individual writes, design, creates and/or chooses back end digital content 20 to be retrieved and displayed for his own use, as a user 24 of the interactive hybrid printed material 22. In another embodiment, the individual may write, design, create, and/or choose the back end digital content 20 to be made available to another individual or group by use of the IHPM 22.

In another embodiment, an individual could choose from, for example, a library of available digital content 20 that is available on a website or on a media storage device to include as back end digital content 20. The chosen material would then be made available by the individual for retrieval and display on the host device 23.

Although the previous examples primarily discuss a teacher-student relationship, the present invention is not necessarily limited to such a situation. For example, instead of a teacher 26, a professor, an educational tutor, a guidance counselor, an employer, a physician, a pediatrician, a psychologist or a psychiatrist may be substituted.

The apparatuses, uses, and methods disclosed herein have been described without reference to specific hardware. However, the apparatuses, uses, and methods disclosed herein have been described in a manner sufficient to enable persons of ordinary skill in the art to readily adapt commercially available hardware as may be needed to reduce any of the embodiments of the present invention to practice without undue experimentation.

Following from the above description and invention summaries, it should be apparent to persons of ordinary skill in the art that, while the methods and apparatuses herein described constitute exemplary embodiments of the present invention, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the identified advantages or objects of the invention disclosed herein in order to fall within the scope of the claims, since inherent and/or unforeseen advantages of the present invention may exist even though they may not have been explicitly discussed herein.

What is claimed is:

1. A content publishing system, comprising:
back end digital content capable of being modified;
an interactive user device displaying fixed front end content, the interactive user device further adapted to transmit one or more request signals associated with the fixed front end content;
a server device adapted to store back end digital content and transmit one or more response signals associated with the back end digital content in response to receiving the or more request signals; and
a user computer device adapted to receive the one or more response signals associated with the back end digital content, the user computer device further adapted to output the back end digital content on an output device;
wherein the one or more response signals correspond to back end digital content.

2. The content publishing system of claim 1, wherein the back end digital content is modified by at least one of a publisher and a third party.

3. The content publishing system of claim 2, wherein the back end digital content is modified by at least one of the publisher and the third party based, at least in part, on at least one of one or more requirement of a user and one or more attribute of the user.

4. The content publishing system of claim 3, wherein the one or more attribute of the user includes at least one of interests, skill levels, learning disabilities and physical disabilities.

5. The content publishing system of claim 2, wherein the back end digital content is modified by at least one of the publisher and the third party based, at least in part, on advice of the third party.

6. The content publishing system of claim 5, wherein the third party is one of a teacher, a professor, an educational tutor, a guidance counselor, an employer, a physician, a pediatrician, a psychologist and a psychiatrist.

7. A method of publishing content, comprising the steps of:
providing a server device for storing digital content, a client device for outputting the digital content, and an interactive user device for generating one or more signal associated with retrieval of the digital content from the server device based, at least in part, on input of a user;
determining by a third party one or more attributes of the user;
modifying the digital content by at least one of a publisher and the third party based, at least in part, on the one or more attributes of the user; and
transmitting the modified digital content from the server device to the client device.

8. The method of publishing content of claim 7, further comprising the step of:
prior to the modifying step, transmitting the one or more attributes of the user to the publisher of the digital content.

9. The method of publishing content of claim 7, further comprising the step of:
prior to the modifying step, creating the digital content by at least one of a publisher and the third party.

10. The method of publishing content of claim 7, further comprising the step of:
prior transmitting the modified digital content from the server device to the client device, transmitting from the interactive user device to the server device the one or more signals associated with retrieval of the digital content.

11. The method of publishing content of claim 7, wherein the third party is one of a teacher, a professor, an educational tutor, a guidance counselor, an employer, a physician, a pediatrician, a psychologist and a psychiatrist.

12. A method of publishing content, comprising the steps of:
providing a server device for storing digital content, a client device for outputting the digital content, and an interactive user device for generating one or more signal associated with retrieval of the digital content from the server device based, at least in part, on input of a first person;
observing a first person by a second person;
determining by the second person one or more needs of the first person based, at least in part, on the observing step;
transmitting from the interactive user device to the server device the one or more signals associated with retrieval of the digital content; and
transmitting from the server device to the client device digital content corresponding to the one or more needs of the first person.

13. The method of publishing content of claim 12, further comprising the step of:
prior to transmitting from the server device to the client device digital content, communicating the one or more needs of the first person by the second person to a publisher.

14. The method of publishing content of claim 12, further comprising the step of:
prior to transmitting from the server device to the client device digital content, modifying the digital content by at least one of a publisher and the second person based, at least in part, on the one or more needs of the first person.

15. The method of publishing content of claim 12, wherein the observing step includes at least one of:
watching the first person interact with at least one of the interactive user device and a third person; and
asking the first person questions associated with the first person.

16. The method of publishing content of claim 12, wherein the second person is one of a teacher, a professor, an educational tutor, a guidance counselor, an employer, a physician, a pediatrician, a psychologist and a psychiatrist.
